(19) United States
(12) Patent Application Publication
(10) Pub. No.: US 2003/0014754 A1
(43) Pub. Date: Jan. 16, 2003

(54) Advertisement response system

(76) Inventor: Vernon S. Chang, San Diego, CA (US)

Correspondence Address: GREENBERG TRAURIG, P.C., 77 WEST WACKER DRIVE, CHICAGO, IL, 60601-1732, US

(21) Appl. No.: 10/182,948

(22) PCT Filed: Feb. 2, 2001
(86) PCT No.: PCT/US01/03435

(30) Foreign Application Priority Data
Feb. 4, 2000 (US) 60180407

(51) Int. Cl. H04N 5/445; G06F 3/00

(52) U.S. Cl. 725/60; 348/51

(57) ABSTRACT

An advertising response system is disclosed for use with a television receiver (10) permitting a viewer to establish a telephone call to an advertiser whose displayed advertisement, having embedded contact information, is received by the system and displayed on the television screen (11). A communication appliance (13) having the ability to establish telephonic communication to between the user and the advertiser receives the advertisement, extracts the embedded contact information and displays an indication that the ad is callback enabled. With the push of a single remote control (14) button, the appliance (13) is commanded to establish a telephone connection between the user and an advertiser. In one embodiment, the remote control (14) includes a microphone (20) whereby the user speaks into the microphone (20) and listens to the television speaker (12) to communicate with the advertiser.

### FIELD OF THE INVENTION

This invention relates to specific technologies and implementations of a new telephonic communication system which enables direct callback to facilitate consumer response to radio, TV or Internet advertising.

### BACKGROUND OF THE INVENTION

Consumers have become accustomed to using various forms of electronic equipment, such as stereos and televisions, to receive content and information which is broadcast over the airwaves and/or wire. With the wide proliferation of cable, and the increasing growth of digital cable, most homes can receive audio, television and movie programming over cable for viewing on a television receiver. While cable service providers indeed possess the infrastructure for distributing broadcast audio and video content, it is not normally considered by the consumer as being useable for providing additional telecommunication functionality.

Contemporary home television brings a convergence of services into the home. Today distributed services may include providing ‘streaming data’ in conjunction with video programming. For example, while watching a sporting event, specific data on the players and teams can be transmitted and displayed alongside the actual live video of the broadcast event. Additionally, ‘data streaming’ can include the transmission of sports scores, financial news, local news, or other information for display during the watching of normal everyday live TV programming.

A further ongoing convergence giving rise to a new class of television products offers the consumer the ability to “surf the web” (Internet) through the home television set. Set-top products and Internet-ready TVs are enabling Internet web surfing and email transmission and reception directly on the TV. In this class of product, navigation and selection of options is normally achieved by using the TV remote control or infra-red keyboard. Web TV is one example of this product class and the capabilities and functions achievable. Indeed, a modern set-top box has become a true appliance providing a gateway to a multitude of services and content accessible through the TV and/or other devices, such as PC's, attached to the broadband connection.

One historical aspect of broadcast radio and television content, namely broadcast advertisements, continues to this day. The broadcast distribution of advertisements now even extends into the Internet. In fact, much of the new convergence and Internet-to-TV services are supported by advertising—ranging from typical Internet-style banner ads to full screen ‘rich media’ video/audio advertisements. User responses to such ads are typically limited to either a text response or “hotlinking” from the advertisement directly to an online website hosted by the advertiser—but only while the user is online and connected to the Internet through an appropriate connection. These response systems do not support telephony interactions or voice communications because the active Internet connection ties up the telephone line connections.

New consumer appliances such as set-top boxes, capable of receiving broadband video and data services (over cable, satellite, microwave, etc . . . ), are emerging. The ability for consumers to interact with these services has also typically been limited to the receipt and transmission of text or preset autoresponse data messages—but only when the user is connected to the Internet. In these cases too, the data transmitted is not voice telephony, only raw digital data. However, telephony is indeed possible directly through set-top box appliances, or in some cases using a traditional telephone handset attached to the set-top box.

The present invention seeks to take advantage of the actual capabilities of such household electronic products, such as the family television set.

It is an object of the present invention to provide for the ability to conduct a telephone conversation using one's television receiver, set-top box and microphone equipped remote control.

It is a further object of the present invention to provide for the receipt of an on-screen advertisement having an embedded telephone number facilitating the auto-callback by the user to the advertiser call center in real-time.

It is another object of the present invention to provide for the archiving of received callback enabled advertisements to permit the user to review and respond to enabled advertisements offline.

Yet another object of the present invention is to permit the user to contact a live operator and/or a computer system in responding to an advertisement response system (ARS) enabled advertisement.

Another object of the present invention is to permit the user to engage in e-commerce by effecting an order for goods and/or services in responding to a received advertisement by transmitting user purchase data.

These and other object of the present invention will become apparent in light the following specification and drawings.

### SUMMARY OF THE INVENTION

According to various embodiments of the present invention, an advertising and telephony system is enabled by a telephone handset using portions of a television receiver and a microphone embedded in a remote control. The disclosed embodiments enable new forms of direct marketing and advertising. Specifically, advertisements and/or email become interactive and enable users to respond immediately and automatically to advertisements and/or email messages or other prompts for information by connecting directly with a live operator at a call center or to a machine driven server based computer system.

A system according to an embodiment of the present invention enables new e-commerce applications by integrating radio or TV, Internet and telephony functionality. The present system enables advertisers to gain significantly increased advertising capabilities through targeted Internet delivered advertising—as opposed to typical broadcast TV ads which reach generic audiences. When advertisers embed information in targeted ads delivered to specific users, they can be immediately reached if the user chooses to initiate the auto-callback system.

The present advertising response system comprises a television and communication appliance having the ability to establish telephonic communication to between the user and the advertiser. The communication appliance includes a central processing unit, control means, a receiver for receiving from a remote system advertisements including embedded contact information, memory for storing the data representative of embedded contact information associated with a received advertisement, a graphics engine for displaying an advertisements on the television display, and telephone interface circuitry for establishing a call over a telephone communication network in response to a user command. Telephone control circuitry serves to simultaneously place a call over the telephone communication network to the advertiser in response to the user selecting an advertisement on the display screen. A remote control device permits the user to control the operation of the television receiver and command that a telephone connection be established between the user and an advertiser whose advertisement is displayed on the television screen. The remote control device further includes user input means and a microphone whereby the user speaks into the microphone and listens to the television speaker to communicate with the advertiser. In one embodiment of the invention the remote control may be integrated into a cordless telephone handset.

As described, the telephone communication network may comprise the public switched telephone network or a computer network and the remote system may comprise cable television provider network.

When responding to an ad, the telephone call may be directed to a person at an advertiser service call center or may be directed to a computer server within an advertiser computer system. One aspect of the invention provides that memory serves to store user purchase information which may be transmitted to the advertiser computer system in response to a user command to make a purchase of goods or services from the advertiser. In each case, the user command is provided by the push of a single button on the remote control or cordless handset.

The embedded contact information included in the ad may be a phone number or an address identifying an advertiser computer server. A storage device may store one or more items of embedded contact information for later recall and review by the user toward the user contacting an advertiser offline. Not only may the system facilitate the user's immediate response to an and, but it may also provide that the user is precluded from establishing telephone communication with the advertiser except during specific pre-arranged times.

A method for permitting a television viewer to automatically and immediately respond to a displayed advertisement having embedded contact information by establishing telephonic communication with the advertiser without the user knowing the advertiser's telephone number and without requiring use of separate telephone device is also disclosed. The method comprises the steps of receiving for display an advertisement having embedded advertiser contact information; viewing the advertisement on a television display; detecting that the advertisement has embedded contact information; indicating to the viewer that the advertisement has embedded contact information; extracting the embedded contact information from the displayed advertisement; and establishing at the user's command a telephonic communication between the viewer and the advertiser, whereby the user is able to speak to the advertiser.

### BRIEF DESCRIPTION OF THE DRAWINGS

FIG. 1 of the drawings is a schematic diagram of a speaker phone implemented through a TV using a set-top cable box, a television receiver and a microphone embedded in a remote control unit;

FIG. 2 of the drawings is a block diagram of the telephone functions partitioned between the remote control unit and the control processing unit in the set-top box;

FIG. 3 of the drawings is a top plan view of a remote control device according to the present invention incorporating a microphone and control buttons for auto-dial callback functions;

FIG. 4 of the drawings illustrates an internet style banner ad according to another embodiment of the present invention illustrating support for auto-dial callback functions:

FIG. 5 of the drawings is a schematic diagram illustrating the two system architectures which support auto-dial callback, where one connection provides voice telephony to a human operator at a call center, and the other provides data transmission to a server or other computing system;

FIGS. 6 & 7 of the drawings is a schematic diagram illustrating other aspects of the system architecture and interconnection to external voice and computer systems; and

FIG. 8 of the drawings is a schematic diagram of the internal components of a set-top box according to the present invention.

### DETAILED DESCRIPTION OF THE DRAWINGS

Voice and audio will play an increasingly important role in both “traditional” consumer electronics as well as the new convergence appliances. Live Internet surfing on the TV requires a connection to the Internet—usually either through a telephone connection or cable. However, there are many applications which can be supported that do not require the user to be actively connected to the Internet. In those cases, the telephone connection is not used and is thus available for supporting telephony applications embedded in both “online” and “offline” applications.

For example, there are many information services which ‘push’ content and data to the user whereby information is stored in a local appliance, such as a set-top box or Internet capable TV, for convenient off-line review. When a user has the opportunity to review the information, it may be reviewed while disconnected from the Internet. In these instances, novel, new forms of interactivity can be created which allows the user to react to the information and instantly gain a telephone connection to the information source.

The present invention also provides that the user may respond to content “pushed” to the user's TV online and in real-time. A new form of interactivity is provided wherein the user can immediately respond to an on-screen advertisement by making a telephone connection to the advertiser via the television and set-top box all without having to even know the phone number of the entity being contacted.

This present invention utilizes an enhanced wired or wireless remote control with an integrated microphone, or alternatively, a cordless telephone handset having remote control functionality integrated therein. It enables a new, unique auto-dialing telephone advertisement response system (ARS) to be implemented by using parts of a stereo or TV (such as speakers). This new auto-callback capability achieves a new generation of interactive advertising which enables advertisers to establish instant and direct contact with consumers at the consumer's discretion.

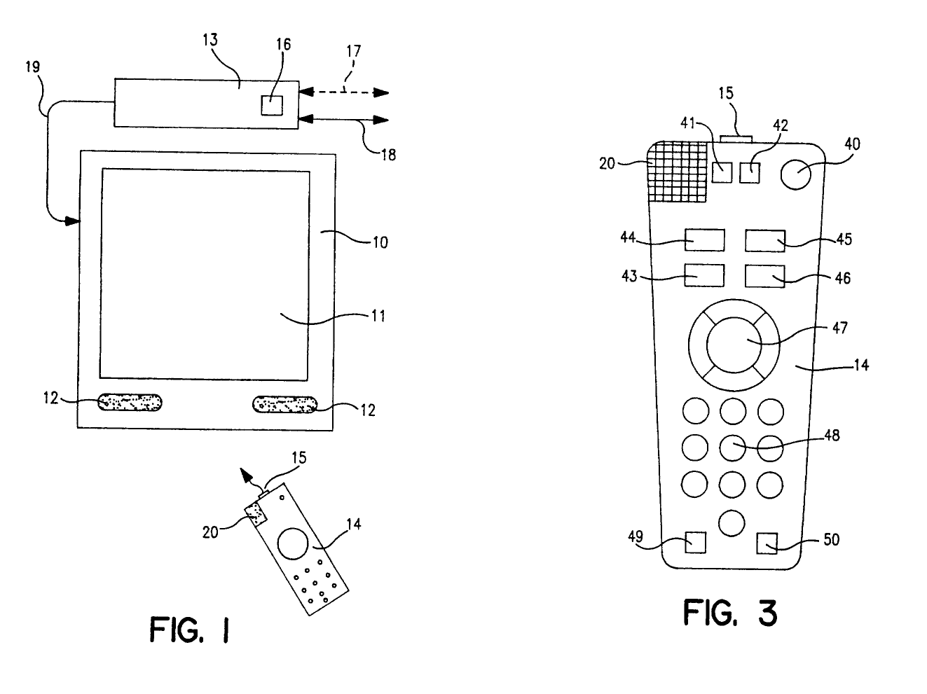

FIG. 1 illustrates a preferred embodiment of the present invention in which a speakerphone telephone function is provided using a telephony equipped consumer appliance (such as a set-top box). The present invention is illustrated as including television receiver 10 having a display screen 11 and audio speakers 12. Set-top box 13 is shown connected to television 10 by connection 19. Set-top box is further shown connected to the cable service provider via connection 18. In one embodiment of the present invention, set-top box 13 may also be connected to the public switched telephone network (PSTN) via connection 17. Also shown is remote control 14. Remote control 14, as further described in FIG. 3, includes emitter 15 which transmits a signal, either by radio frequency (RF) or by infra-red (IR) to a receiver 16 incorporated in set-top box 13.

As illustrated, the internal TV speakers 12 (or external audio speakers) function as the telephone “earpiece” permitting the user to hear the telephone conversation. The remote control 14, either wired or wireless, is illustrated as including an integrated microphone 20 which functions as the telephone “mouthpiece”. In another embodiment of the present invention the remote control comprises a cordless telephone, and in particular, the handset component of the cordless telephone. The device may thus resemble a conventional cordless handset having remote control buttons positioned on, for example, the back side of the handset. Special additional buttons may be placed on the normal telephone side of the handset such as for auto dialback to advertisements. In this embodiment the phone handset mouthpiece is the input microphone and the TV speaker functionality is optional and may or may not be used since there is an earpiece in the phone handset.

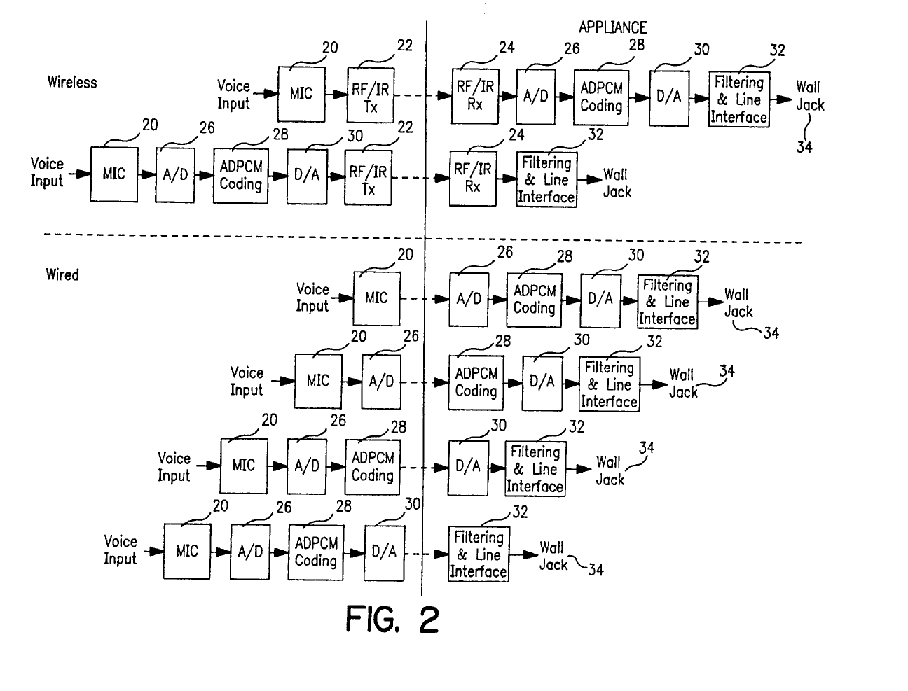

As shown in FIG. 2. telephone processing, including digitization, filtering and coding (such as Adaptive Differential Pulse Code Modulation, “ADPCM”), is performed in part or in whole by combination of the TV 10 and set-top box 13. Both a wired and wireless embodiment is illustrated showing both the remote control and set-top box 13 components. As shown, remote control 14 includes a microphone 20, a RF or IR transmitter 22 as well as the associated analog-to-digital converter 26, ADPCM coding device 28, digital-to-analog converter 30, and in the set-top box appliance, a RF or IR receiver 24, analog-to-digital converter 26, ADPCM coding device 28, digital-to-analog converter 30 and liner interface 32 which connects to wall jack 34. A wireless remote control 14 according to an alternative embodiment of the invention includes A/D 26, ADPCM coding device 28, D/A 30 and filtering and line interface 32. According to alternative embodiments, various devices in the processing path may be incorporated into remote 14.

The audio output circuitry includes gain control and drivers to: 1) send signals out to mono or stereo consumer electronics audio cables; 2) send audio out to standalone speakers; 3) output baseband audio; 4) send audio output for processing to modulate and insert the audio into a video carrier (such as NTSC, PAL and SECAM) for playback through a TV on a modulated TV channel.

FIG. 3 illustrates a remote control 14 according to one embodiment of the present invention. Audio output circuitry is integrated into the wired or wireless consumer electronics remote control 14 (such as the type used to control a TV, VCR or stereo) together with a microphone 20 to acquire voice input. The audio input circuits associated with microphone 20 may include digitalization, voice coding, voice compression or voice recognition, or may merely pass an analog voice signal to set-top box 13 for processing. Audio input may be any form of audio input including, but not limited to, voice, music, instruments, etc. In the context of the present invention, the audio input will typically comprise the user's voice. In the illustrated embodiment, remote control 14 includes the following control buttons, power button 40, TV and VCR buttons, 41 and 42, email control button 43, ad response callback button 44, play button 45, microphone on button 46, cursor control button matrix 47, keypad 48, and clock and mute buttons 49 and 50. In the embodiment illustrated, remote control 14 is a wireless device, however, it may be implemented as a wired device without departing from the scope of the invention.

According to the present invention, the automatic dialing function is initiated from the remote control by push of a single button on remote 14. The remote control 14 can initiate an auto-callback telephone function when a user wishes to respond to an advertisement or email appear on screen. Upon hearing, seeing or reading an auto-callback enabled advertisement or email, the user may depress a single button 44 on the remote control 14 which initiates the set-top box appliance processing unit to establish a telephone call to the advertiser either via cable or the PSTN. The user may then directly engage in communication with the sending advertiser or email author to talk, collect information, or conduct a transaction. According to this aspect of the invention the user does not require a separate telephone and does not have to retrieve paper and pencil to write down a response telephone number which appears on or in the ad, and instead can react to an ad or email immediately. In fact, as described herein, the user need not even know the telephone number of the person being contacted. This single button callback also applies to non-voice telephony auto-callback applications where the user's appliance may call an advertiser's computing system to place an electronic order where the appliance retrieves the user's order command and/or password stored therein and submits an electronic order when the appliance connects to the system.

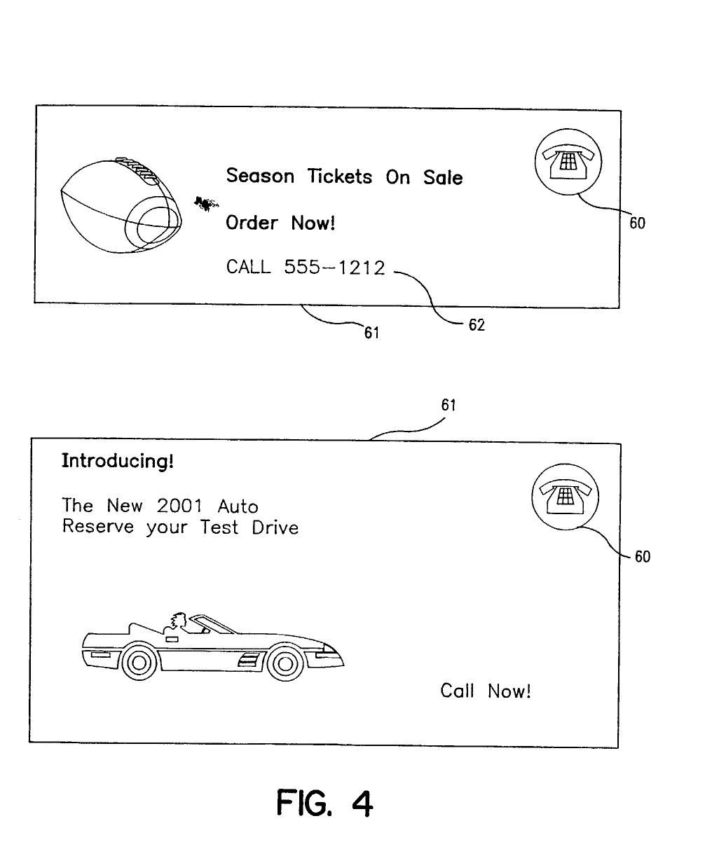

According to the present invention, telephone numbers are embedded as a data elements within advertisements such as those illustrated in FIG. 4, or may be embedded in the header section of an email as described herein. As illustrated, advertisements 61 may take the form of static images containing text and graphics. These advertisements include an embedded callback number and may or may not display the telephone number 62. In each case the telephone number is included in a pre-defined stream of digital information forming a portion of the advertisement being displayed and is extracted from the data stream by the set-top box processing unit. Icon 60 in the advertisement notifies the user that the ad being viewed is auto callback enabled. This callback number may be stored and used whenever the user elects to initiate a callback function. The embedded phone number thus provides a system whereby consumers can immediately and impulsively respond to advertisements and emails without leaving their surroundings and can establish a direct telephone link with the sender.

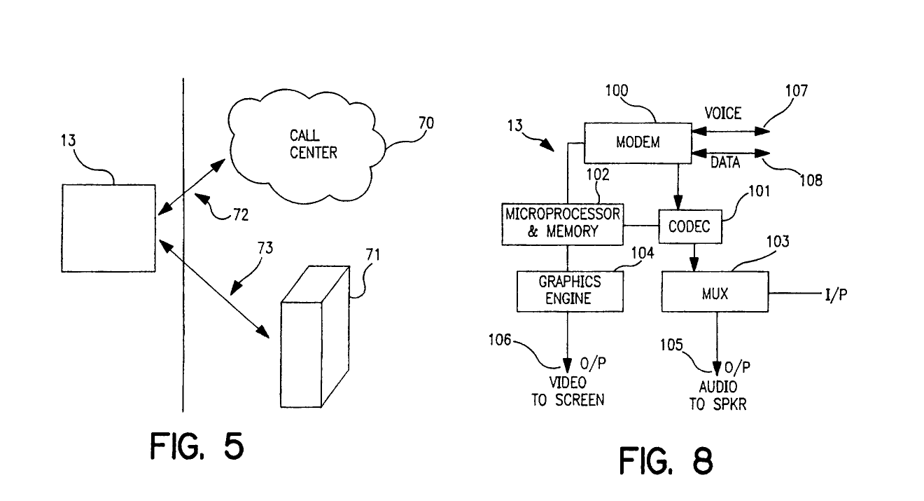

Another embodiment shown in FIG. 5 illustrates the capability to callback to a person. In this case, the system connects the user with an operator or employee in a call center 70 for the company which placed the advertisement over a voice connection 72 between set-top box 13 and the operator. An alternate embodiment shown in FIG. 5 includes the capability to callback to a server 71, as opposed to a person. In this case, the system connects to a server 71 and automatically sends pre-stored information which can be correlated to an advertising event over a data connection 73 between box 13 and server 71. For example, pre-stored information could include the user's name, address and the date and time. The user's name and address can be used to reference a database containing the user's preferred credit card information. The date and time can be used to correlate with an ad that is being presented to the user.

Another embodiment enabling auto-callback uses pre-arranged, pre-stored data which is not embedded in an advertisement. According to this embodiment telephone numbers are pre-stored in the set-top box appliance and are used in the automatic response system in applications which are not specifically associated with advertisements or Internet e-Commerce. One example includes home shopping channels and other special broadcast advertisements. These channels initially send the user's Internet TV or set-top box appliance a pre-determined number. The user may configure the box to associate this number with a particular memory location and/or remote control button. Accordingly, this number may be activated and thus dialed by pushing a programmable button on the remote control 14, such a dedicated button for the home shopping channel.

In a still further embodiment of the present invention a specific callback number can be set up to be active only during specific times and dates. For example, a special number may be reserved for use only during half-time of a football game. This number would have been delivered and pre-stored in an appliance (such as an Internet TV or set-top box) at the user's home. It would be activated only during the specific time(s).

Additionally it is contemplated that one or more callback numbers may be stored in the set-top box for off-line review and use thereby creating a personal ad file. A user may thus review the stored callback-capable advertisements, scrolling through them, much as one might review phone book yellow pages. The user may thus select and activate an callback-capable advertisement at any time. The response may be to establish a voice connection or a data transmission.

In a first example of the operation of the present invention a user is viewing a broadcast television program such as a football game. A user may choose to make a phone call during the program to, for example, speak with a friend about how their favorite team is performing. The present invention enables the user to place a call and conduct a normal telephone conversation using the remote control to receive the calling party's voice and the television speaker or a speaker integral to the set-top box appliance to hear the called party's voice during the call. If the TV speakers are used the user cannot listen to the television broadcast while conducting a telephone conversation.

In a second example a user may respond in real time to an advertisement which appears on the TV screen. A particular advertisement displayed on a TV or transmitted over a radio channel, in real time, may prove interesting to the listener. The moment the listener hears the ad the listener using the present invention has the ability with the push of a single button on the remote control to automatically telephone the company placing the ad. The user may then engage in a normal telephone conversation with the advertising company's call service center to get more information on the product or service featured in the ad, order the product or service, or provide other feedback. In such cases, the callback telephone number is already pre-arranged and prestored in the processing unit of the set-top box appliance.

In a third example of the present invention, a user may respond off-line to an embedded internet style ad. Advertisements can be normal broadcast ads (such as TV commercials) or embedded ads which may be pre-stored in a device connected to the TV (such as an Internet-TV or set-top box). For example, web pages, email, or other information may be stored in a set-top box appliance for convenient leisurely offline review by a user. When the user reviews the information, there may be ads with embedded data which the user could select for auto-dial connection to the advertising company.

For example, a nationwide pizza chain may choose to use this system to send advertisements for home delivery of pizzas. The distributed ads, embedded in user information services such an email or newsletter, may contain embedded data comprising the appropriate phone number for a local pizza outlet. Thus, wherever the user is located, if they so decide, the user can order a pizza by using the system to auto-dial their local pizza outlet and speak to a person to place an order.

Automatic response system enabled emails may take the form of targeted advertising, or may simply comprise e personal messages. The system enables users to directly telephone back the sender of the email if the email is so enabled. For example, a message from a relative could be enabled according to the present system so that the recipient is encouraged to immediately call the sender when the email is received.

A fourth example provides for the automatic callback to a server, as opposed to a human. Either real time or stored advertising can be responded to with a data transmission from the home appliance (TV, stereo, PC or set-top box). For example, a user may see an ad for a new CD just released. The user could push a single button on the remote control and cause the system to auto-dial the advertiser and send previously stored information to the advertiser's computing center to thereby place an order for the purchase of the CD. This information is arranged to effect the purchase transaction whereby the user buys the advertised CD by a simple single button push on a remote control.

In a fifth example the callback feature of the present invention may be used to respond to surveys. Surveys may be sent to users through an Internet-type appliance such as a set-top box. Users may choose to reply to the survey request by initiating the auto-callback function of the present invention and speak directly with the marketer, be it a person or computerized voice synthesized system.

In a sixth example, a user may be watching a home shopping channel on TV. When the user wishes to purchase an advertised product, the user only needs to push a single button on the remote control to activate the auto-dial-up feature using a pre-arranged pre-stored callback number. The user is thus connected, as on a telephone, to the service call center for the shopping channel. This may also be implemented where the appliance calls a server and simply delivers user information to effect the purchase.

Each of foregoing Examples illustrates a novel feature of the invention wherein the user via a remote control together with the TV speakers can engage in telephone communication without the use of a conventional telephone set. Alternatively, users may engage the novel telephone dial-back capability using a combination telephone handset and remote control.

The present invention thus further affords a superior level of convenience and control for the consumer. For example, the user may choose to ignore the interactive callback ads, or may respond if desired without moving from their current location. The present invention eliminates the need to memorize or write down callback numbers as well as the need to go and retrieve a telephone to respond to an ad.

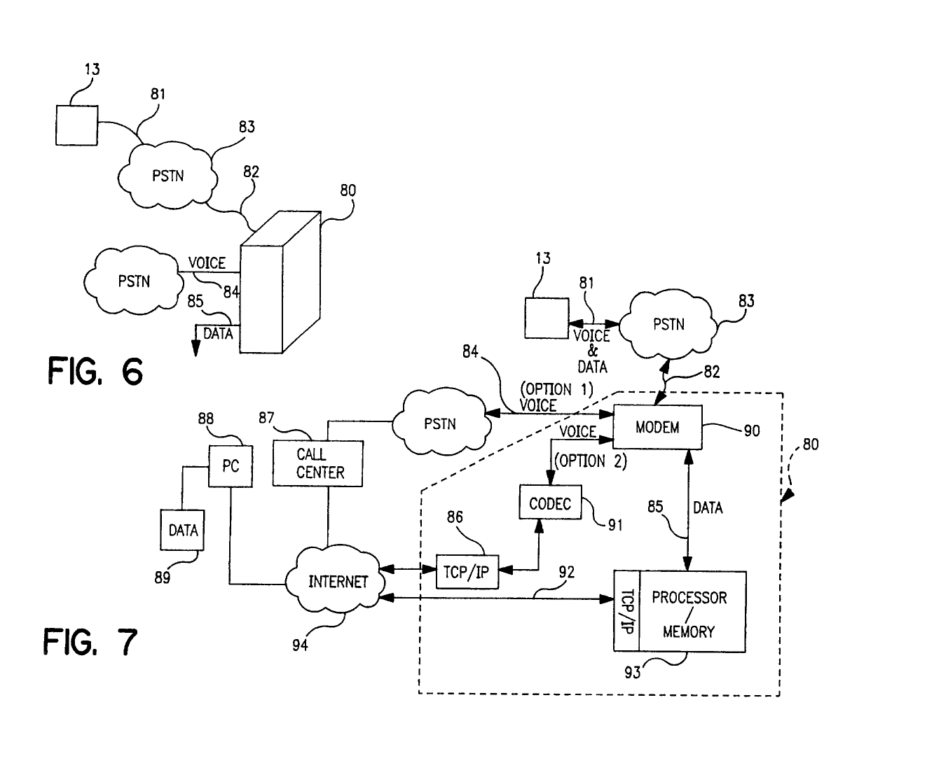

According to one embodiment of the present invention illustrated in FIGS. 6 and 7, the appliance 13 transmits voice and user information simultaneously so that the user can use the appliance's telephone function to speak with an advertisers representative while the representative's computer simultaneously communicates with the user's appliance. According to a preferred embodiment of the invention, advertisements broadcast to the consumer include embedded contact information including a telephone number for the advertiser's call center and an address for the advertiser's computer system. When the advertisement is displayed, the user may select the ad with the remote control. The appliance in turn connects the user to a server over the telephone network 83. The links 81 and 82 can be voice-over IP, IP telephony, a proprietary protocol, or other suitable protocol.

The appliance 13 transmits the advertiser contact information to the server 80. The server 80 uses the contact information to make two separate connections, a telephone connection 84 to the advertiser's call center 87, and a computer connection 85 to the advertiser's computer system.

The server is shown as including a modem 90, for example a V.42 modem, to separate the voice data and user information from the appliance. The server makes a telephone connection over a normal PSTN connection 84. Alternatively, the server can utilize internet telephony, using a voice codec 91 to convert the data into data packets for transmission over a network layer 86 using TCP/IP protocol to communicate with the call center 87 via the Internet. Processor 93 connects to the advertiser's computer network over a regular computer network connection 92 such as the internet 94.

During this connection, the user speaks with the advertiser representative at call center 87 regarding a product or purchase, and the representative using a PC 88 can transmit text and/or graphical information to the user's appliance 13 for display. The information transmitted may originate from the representative's PC 88 or server system, or may be retrieved from prestored information in the network operator's data server 89.

For example, an ad for a travel agency is displayed on the user's television screen, and the user decides (s)he wold like to plan a trip to Hawaii. The user selects the advertisement with the remote control and the appliance automatically makes simultaneous telephone and computer connections to the agency's call center and computer network, respectively, using the embedded contact information in the advertisement.

While the user speaks with the travel agent, the travel agent is able to transmit useful information back to the user's appliance via the computer network connection to assist in the transaction. This information could include, for example, a list of available flights from the local airport(s), a photograph of a hotel, and a map of the island indicating the location of the hotel.

While the foregoing examples primarily address the use of the present invention in association with advertising, it also has utility when used in association with email that may be received and viewed on a TV.

According to an embodiment of the invention, the appliance receives email messages from an internet connection established by the set-top box appliance, or the cable service provider who in turn transmits the email to the box in the user's home for display on the television screen. The user thus may browse the stored email offline. Data representative of the sender's telephone number may be formatted into the email message. The appliance thus extracts and converts this data and automatically dials the telephone number in response to a user command, for example, the pressing of the telephone icon button on the remote while in the email mode. If a telephone number is detected in the email, the appliance displays an alert icon on the screen indicating to the user that they can call the sender immediately from the email environment.

Email messages are sent over networks using email protocols such as SMTP, IMAP and POP3. Email messages contain header portions that include routing information and a body that contains the text of the message. The information in the header is used by the email system software to route the email message between the sender and the recipient. According to this embodiment, the telephone number of the email sender is embedded directly into the header of the email message in a prescribed location and/or manner such as a specific character sequence which either or both precedes or postcedes the actual telephone number. Alternatively, the data representative of the telephone is formatted in a data block in a prescribed location not in the header, but a flag or other indicia is contained in the header indicating that the email message contains such a data block.

Software applications are known that search the text of email messages for number strings that resemble telephone numbers and then use those number to place a telephone call. However, these applications are prone to errors. They may erroneously identify number strings that are not telephone numbers. Furthermore, they are relatively slow because they must search through the entire textual content of the message. The present invitation is an improvement over such applications. It is faster and more accurate because no scanning is necessary since the telephone number is always in the same place in the email message or is specifically identified through an identifying character sequence.

The user may configure his or her screen interface to utilize the extracted telephone number according to the user's preferences. The user may configure the interface to automatically dial a telephone number extracted from the header upon opening the email message, or alternatively, only dial the number when the telephone button is pressed. When creating messages or responding to sent messages, the user may configure the system to automatically embed the user's telephone number in the header of the outgoing email message.

The present embodiment is especially useful for entities that advertise on the internet using email messages because the user can automatically telephone the advertiser's call center upon opening the email advertisement.

Software agents and robots (also known as bots, spiders, and metacrawlers) allow individuals to search content on the internet for information of particular interest. According to one embodiment, the user instructs a robot to find a desired item for purchase on the internet. The robot locates the web sites of retailers that offer the item, copies the telephone number from the web site, creates a notice email addressed to the user, and formats the retailer's telephone number in the header of the email. When the user opens the email, (s)he can instruct the appliance to call the retailer automatically from the email environment and place an order for the desired item.

FIG. 8 of the drawings is a schematic diagram of the internal components of a set-top box according to the present invention. In one embodiment, set-top box 13 includes a modem 100 accepting voice and data connections 107 and 108 to the cable operator. Microprocessor and memory 102 serves to control the overall operation of the unit including codec 101, graphics engine and mux 103. Output 105 provides an audio output to the audio speakers of the television while output 106 provides a video output to the television screen.

The present embodiment may be implemented in other environments commonly used for email correspondence such as a personal computer or a portable device such as a portable PC, hand-held computers and organizers, and mobile phones with email paging capabilities. An example of such an embodiment is for mobile phones with email receive capability to either automatically or upon user command dial-back to the sender of an email.

It is envisioned that the embodiments of the present invention may be implemented in hardware or software, or a combination of both (e.g., programmable logic arrays). Unless otherwise specified, the algorithms included as part of the invention are not inherently related to any particular computer or other apparatus. In particular, various general purpose machines may be used with programs written in accordance with the teachings known to those in the art, or it may be more convenient to construct more specialized apparatus to perform the required method steps. However, preferably, the invention is implemented in one or more computer programs executing on programmable systems each comprising at least one processor, at least one data storage system (including volatile and non-volatile memory and/or storage elements), at least one input device, and at least one output device. Program code is applied to input data to perform the functions described herein and generate output information. The output information is applied to one or more output devices, in know fashion.

Each such program may be implemented in any desired computer language (including machine, assembly, high level procedural, or object oriented programming languages) to communicate with a computer system. In any case, the language may be a compiled or interpreted language.

Each such computer program is preferably stored on a storage media or device (e.g., ROM, CD-ROM, or magnetic or optical media) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

The foregoing description and drawings are merely to explain and illustrate the invention, and the invention is not limited thereto except insofar as the independent claims are so limited, as those skilled in the art with the present disclosure before them will be able to make modifications and variations therein without departing from the scope of the invention.

What is claimed is:

1. An advertising response system for use with a television receiver including a display screen, a speaker; and a remote control including a user input means and a microphone; and a communication appliance operably connected to the television receiver and the remote control; the advertising response system comprising:
a central processing unit,
means for receiving data representative of advertisements from a networked computer system,
means for storing the data representative of advertisements and containing data representative of a telephone number of a particular advertiser and an address of the particular advertisers computer,
means for displaying at least one of said advertisements on the display screen,
means for placing a call over a telephone network in response to a user command,
means for receiving a first audio signal from the microphone of the remote control,
means for transmitting said first audio signal over the telephone network during the call,
means for receiving a second audio signal from the telephone network and outputting the second audio signal through the speaker during a call,
means for storing user purchase information, and
means for simultaneously placing a call over the telephone network to the advertiser and connecting to the advertiser computer over the computer network in response to the user selecting an advertisement on the display screen.

2. An advertising response system for use with a television receiver including a display screen, a speaker; a remote control including a user input means and a microphone wherein the television receiver is connected to a communication appliance; the advertising response system comprising:
a communication appliance connected to the television receiver and a remote computer system having the ability to establish a telephone communication link, the communication device including a central processing unit, control means, a receiver for receiving data representative of advertisements from a remote computer system, memory for storing data representative of a telephone number of a particular advertiser and an address of the particular advertiser's computer,
graphics engine for displaying at least one of said advertisements on the display screen,
telephone interface circuitry for placing a telephone call over a Communication network in response to a user command,
first audio signal receiver for receiving a first audio signal from the microphone of the remote control,
audio signal transmitter for transmitting said first audio signal over the telephone network during the call,
second audio signal receiver for receiving a audio voice signal from the telephone network and outputting the signal through the speaker during a call,
control circuitry for simultaneously placing a call over the communication network to the advertiser and connecting to the advertiser computer over the computer network in response to the user selecting an advertisement on the display screen.

3. The invention according to claim 2 further including memory for storing user purchase information which may be transmitted to the advertiser computer system in response to a user command to make a purchase.

4. The invention according to claim 2 wherein the communication network comprises the public switched telephone network.

5. The invention according to claim 2 wherein the communication network comprises the Internet.

6. An advertising response system for use with a television receiver having a display and associated audio speaker for permitting a television viewer to establish a telephone call to an advertiser whose displayed advertisement, having embedded contact information, is received by the system and displayed on the television screen, the advertising response system comprising:
a communication appliance having the ability to establish telephonic communication to between the user and the advertiser, the communication device including:
central processing unit,
control means,
receiver for receiving from a remote system advertisements including embedded contact information,
memory for storing the data representative of embedded contact information associated with a received advertisement,
graphics engine for displaying an advertisements on the television display,
telephone interface circuitry for establishing a call over a telephone communication network in response to a user command,
telephone control circuitry for simultaneously placing a call over the telephone communication network to the advertiser in response to the user selecting an advertisement on the display screen; and
a remote control device for permitting the user to control the operation of the television receiver and command that a telephone connection be established between the user and an advertiser whose advertisement is displayed on the television screen; the remote control device further including user input means and a microphone whereby the user speaks into the microphone and listens to the television speaker to communicate with the advertiser.

7. The invention according to claim 6 wherein the telephone communication network comprises the public switched telephone network.

8. The invention according to claim 6 wherein the telephone communication network comprises a computer network over which telephone calls are connected.

9. The invention according to claim 6 wherein the remote system comprises a cable television provider network.

10. The invention according to claim 8 wherein the computer network comprises the Internet.

11. The invention according to claim 8 wherein the computer network comprises a cable television provider network.

12. The invention according to claim 6 wherein the telephone call is directed to a person at an advertiser service call center.

13. The invention according to claim 6 wherein the telephone call is directed to a computer server within an advertiser computer system.

14. The invention according to claim 6 further including memory for storing user purchase information which may be transmitted to the advertiser computer system in response to a user command to make a purchase of goods or services from the advertiser.

15. The invention according to claim 6 wherein the user command is provided by a single button on the remote control.

16. The invention according to claim 6 wherein the embedded contact information comprises a telephone number.

17. The invention according to claim 6 wherein the embedded contact information comprises an address identifying an advertiser computer server.

18. The invention according to claim 6 further including a storage device for storing one or more items of embedded contact information for later recall and review by the user toward the user contacting an advertiser offline.

19. The invention according to claim 18 wherein the user command is provided by a single button on the remote control.

20. The invention according to claim 6 wherein the embedded contact information includes data elements which prevent the user from establishing telephone communication with the advertiser except during specific prearranged times.

21. A method for permitting a television viewer to automatically and immediately respond to a displayed advertisement having embedded contact information by establishing telephonic communication with the advertiser without the user knowing the advertiser's telephone number and without requiring use of separate telephone device, the method comprising:
receiving for display an advertisement having embedded advertiser contact information;
viewing the advertisement on a television display;
detecting that the advertisement has embedded contact information;
indicating to the viewer that the advertisement has embedded contact information;
extracting the embedded contact information from the displayed advertisement;
establishing at the user's command a telephonic communication between the viewer and the advertiser
whereby the user is able to speak to the advertiser.

22. The invention according to claim 21 wherein the command to establish a telephone connection between the viewer and the advertiser is given by the user's push of a single button on the remote control.

23. The invention according to claim 21 wherein the step of establishing a telephone connection between the viewer and the advertiser in response to the command establishes telephonic communication with a live person at an service call center.

24. The invention according to claim 21 wherein the step of establishing a telephone connection between the viewer and the advertiser in response to the command establishes telephonic communication with a server at an advertiser computer network.

25. The invention according to claim 21 wherein the method further includes the step of storing the extracted contact information for later review by the user and offline communication between the viewer and the advertiser.

26. The invention according to claim 21 wherein the invention further includes the step of retrieving stored contact information toward establishing telephonic communication with the advertiser.

27. The invention according to claim 21 wherein the step of indicating to the viewer that the view can immediately establish telephone communication with an advertiser comprises the step of displaying an icon on the television screen.

28. A advertising response system including a television having a display screen, a speaker, a remote control including a input means and a microphone, a communication appliance operably connected to the remote control, the television, and the speaker, the advertising response system comprising:
a central processing unit,
storage means,
means for receiving data representative of advertisement from a networked computer system,
means for storing the data representative of advertisements,
means for displaying at least one of the said advertisements on the display screen,
means for placing a call over a telephone network in response to a user command,
means for receiving a first audio signal over the telephone network during the call,
means for receiving a audio voice signal from the telephone network and outputting the signal through the speaker during the call,
means for receiving an email message over the networked computer system, said email message comprising data representative of the sender's telephone number in a header portion of the email message,
means for extracting the telephone number from the email header portion, and
means for using the telephone number to place a call in response to a user command.
